(19) United States
(12) Patent Application Publication
(10) Pub. No.: US 2005/0118968 A1
(43) Pub. Date: Jun. 2, 2005

(54) Double conversion tuner

(75) Inventor: Nick Cowley, Swindon (GB)

Correspondence Address: ARENT FOX KINTNER PLOTKIN & KAHN, 1050 CONNECTICUT AVENUE, N.W., SUITE 400, WASHINGTON, DC, 20036, US

(73) Assignee: ZARLINK SEMICONDUCTOR LIMITED

(21) Appl. No.: 10/992,785

(22) Filed: Nov. 22, 2004

(30) Foreign Application Priority Data
Nov. 27, 2003 (GB) 0327542.7

(51) Int. Cl. H04B 1/18; H04B 1/16; H04B 1/26

(52) U.S. Cl. 455/188.1; 455/205; 455/314; 455/339

(57) ABSTRACT

A tuner comprising a signal input 2 for receiving an input signal comprising multichannel data, a filter 3 having an input coupled to said signal input, the filter being tunable to pass a selected frequency channel, a first frequency changer 8 having an input coupled to an output of said filter 3 and arranged to upconvert the filtered input signal so that said selected frequency channel is shifted to a predefined high intermediate frequency, a second filter 9 having an input coupled to an output of said first mixer 9 and arranged to pass said predefined high intermediate frequency, and a second frequency shifter 12 having an input coupled to an output of said second filter 9 and arranged to downconvert the filtered high intermediate frequency to a predefined output frequency.

### FIELD OF THE INVENTION

The present invention relates to a double conversion tuner and in particular though not necessarily to a double conversion tuner suitable for use in a digital terrestrial television or radio tuner.

### BACKGROUND TO THE INVENTION

The basic purpose of a tuner in a digital terrestrial television (or radio) receiver is to amplify and downconvert radio frequency (RF) signals received by an antennae, to an appropriate intermediate frequency (IF) for further filtering and demodulation. Two known tuner architectures are the single conversion tuner and the double conversion tuner.

Single Conversion Tuner

The single conversion architecture (illustrated in FIG. 1) has been the traditional approach for over the air broadcast applications. The basic principle of single conversion is to heavily filter out all undesired channels, and then feed the single desired channel to a mixer where it is downconverted to the IF frequency. Since the required channel will vary in frequency, the pre-mixer filters also have to be tuneable. These tuneable filters and the required local oscillator will be limited by practical component values and application limitations to approximately 1 octave of frequency range. To cover the full RF broadcast range of 54-860 MHz, the RF has typically to be split into three bands. To allow for received amplitude variation, each channel contains a variable gain stage.

Double Conversion Tuner

The double conversion architecture (illustrated in FIG. 2) has traditionally been used in cable broadcast applications. The basic principal of double conversion is to “block” upconvert the unfiltered RF spectrum to a high IF Frequency at which a fixed frequency (HIIF) channel filter is applied. The output of the filter is then downconverted to the same output IF frequency as in the single conversion approach. The main purpose of the fixed high IF filter is to achieve image rejection and obtain signal strength protection for the downconversion stage.

Historically single conversion has been applied to ‘over the air’ systems where the advantages of superior selectively in the presence of stronger undesired channel performance is desirable. In cable systems, such selectivity is not generally an issue as all channels are broadly at the same power. Because of the use of block conversion (i.e. a broadband input), the double conversion tuner tends to have superior inter/cross modulation performance, particularly in the presence of illegal channel infiling as occurs in cable systems.

Where possible, the preferred solution in many applications is the single conversion tuner. This is based both on the lower cost of the single conversion architecture and on the ready availability of assembled and tested modules which can be easily sourced so reducing development time and risk. A disadvantage of the architecture however is that alignment of the tracking filters is required at the production stage in order to provide the required tuner selectivity. Alignment typically involves a human operator “tweaking” the values of one or more wire coil inductors to achieve a desired output for a given input. This procedure does not lend itself to the integration of the tuner onto a motherboard as the transport of a motherboard along an assembly line to allow the alignment procedure to be carried out is undesirable. An additional disadvantage is the cost associated with reworking a whole motherboard in the event of a faulty tuner which in production terms should represent only a small proportion of the overall system cost.

The double conversion tuner, which is essentially broadband in nature, requires two high performance mixer oscillator stages plus a high Q fixed frequency filter, for example a surface acoustic wave (SAW) filter. This architecture eliminates the need for production alignment and offers the possibility of integrating the tuner directly onto a motherboard. However the incremental saving afforded by avoiding the need for an alignment process is relatively small and does not offset the other costs of the double conversion architecture vis-à-vis the single conversion architecture (in practice motherboard integration is difficult to achieve).

The Advanced Television Systems Committee (ATSC) standards for the broadcasting of terrestrial digital television signals, call for the ability to receive a digital channel in the presence of an immediate adjacent channel at +39 dBc. The relative amplitude of other interferers can be as high as 63 dBc. Both existing single and double conversion architectures struggle to achieve the required performance in the presence of such interferers.

In the case of the double conversion architecture, the upconversion stage can be designed to handle the desired-to-undesired (D/U) ratio of a near adjacent. However there may be problems in the downconverter procedure as a typical high IF filter will pass the higher amplitude adjacent to the downconverter and hence cause overload in this section. This can be overcome by applying a higher cost narrow band high IF filter. The D/U ratio to far out interferers will be significantly higher than to immediate adjacents and these may well lead to compression in the upconverter. This problem will be further compounded in practical installations as the receiver may ‘see’ a number of these interferers, leading to a high composite undesired at the input which could easily lead to compression and distortions of the desired channel.

In the case of the single conversion architecture, the tuner will have front end tracking filters, which will only pass the desired and immediate adjacents. This will effectively reject the far out interferers and so overcome this problem. However current state of the art mixer oscillator circuits for single conversion are designed principally to satisfy analogue transmission requirements where adjacent interferers are not an issue, and hence the performance in a digital application with high amplitude adjacent interferers is limited.

### SUMMARY OF THE INVENTION

It is an object of the present invention to provide a digital tuner which overcomes the problems associated with conventional single and double conversion tuner architectures. This and other objects are achieved by introducing tuneable filters into the conventional double conversion tuner architecture.

According to a first aspect of the present invention there is provided a tuner comprising:
a signal input for receiving an input signal comprising multichannel data;
a filter having an input coupled to said signal input, the filter being tunable to pass a selected frequency channel;
a first frequency changer having an input coupled to an output of said filter and arranged to upconvert the filtered input signal so that said selected frequency channel is shifted to a predefined high intermediate frequency;
a second filter having an input coupled to an output of said first frequency changer and arranged to pass said predefined high intermediate frequency; and
a second frequency shifter having an input coupled to an output of said second filter and arranged to downconvert the filtered high intermediate frequency to a predefined output frequency.

In a typical arrangement, the tuner comprises a controller arranged to tune the first mentioned filter and the first frequency changer.

In one embodiment of the tuner, the first mentioned filter comprises at least two sub-filters, the passbands of the sub-filters being substantially contiguous, and the sub-filters being selectably coupled between the input and output of the filter to provide the tuning. The passbands and centre frequencies of the sub-filters may be individually tuneable.

The second filter may have a fixed centre frequency and passband, or one or both of these may be variable by tuning the second filter.

The input signal to the tuner typically comprises both analogue and digital data, although this need not be the case. The wanted data is typically digital data.

According to a second aspect of the present invention there is provided a tuner comprising:
a signal input for receiving an input signal comprising multichannel data;
a filter having an input coupled to said signal input, the filter being arranged to pass a selected frequency channel;
a first frequency changer having an input coupled to an output of said filter and arranged to upconvert the filtered input signal so that said selected frequency channel is shifted to a predefined high intermediate frequency;
a second filter having an input coupled to an output of said first mixer, the second filter being tuneable so as to pass said predefined high intermediate frequency; and
a second frequency shifter having an input coupled to an output of said second filter and arranged to downconvert the filtered high intermediate frequency to a predefined output frequency.

In a typical arrangement, the tuner comprises a controller arranged to tune said second filter and the first frequency changer.

Embodiments of the present invention are suited to both upintegration and to implementation on a motherboard.

### BRIEF DESCRIPTION OF THE DRAWINGS

FIG. 1 illustrates schematically a conventional single conversion tuner;

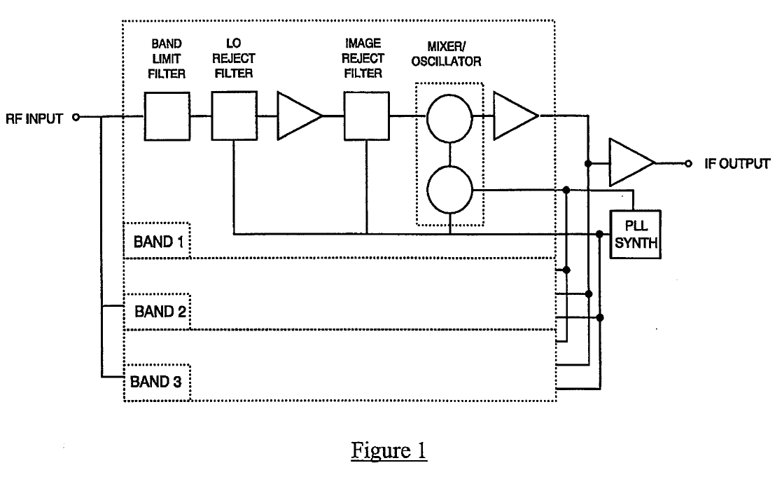

FIG. 2 illustrates schematically a conventional double conversion tuner;

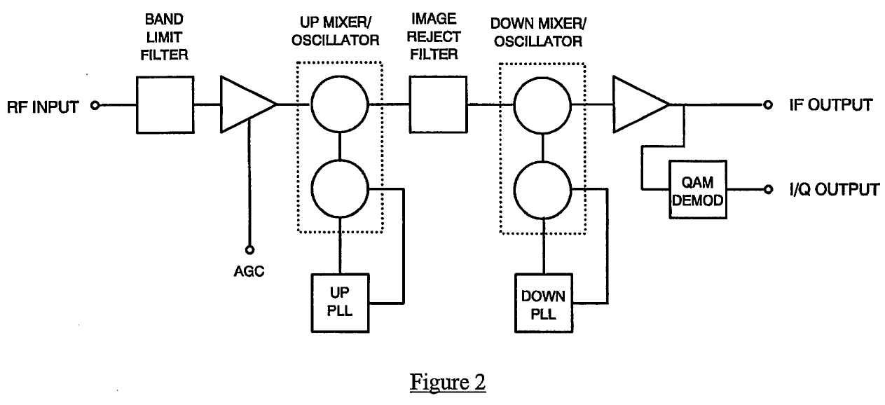

FIG. 3 illustrates schematically a double conversion tuner embodying the present invention;

FIG. 4 illustrates schematically a first filter arrangement of the tuner of FIG. 3;

FIG. 5 illustrates schematically a second filter arrangement of the tuner of FIG. 3; and

FIG. 6 illustrates schematically an alternative second filter arrangement of the tuner of FIG. 3.

### DETAILED DESCRIPTION OF PREFERRED EMBODIMENTS

The principles of operation of the embodiments of the invention which will be described below are as follows:

The input spectrum is broadband in nature and contains undesired interferers as well as the desired signal. These undesired may be significantly greater in amplitude than the desired signals.

The input signal is first presented to a filter stage which will pass the desired channel plus some of the adjacent channels, whilst providing attenuation to far out interferers.

The filtered spectrum is passed to the upconverter, which block upconverts the output of the filter to a high IF frequency.

A high IF filter will filter out substantially all but the desired channel and pass the filtered signal to a downconverter, which will convert the desired to a standard output IF frequency.

Either or both of the filters may be adjustable in terms of their centre frequency or bandwidth or both.

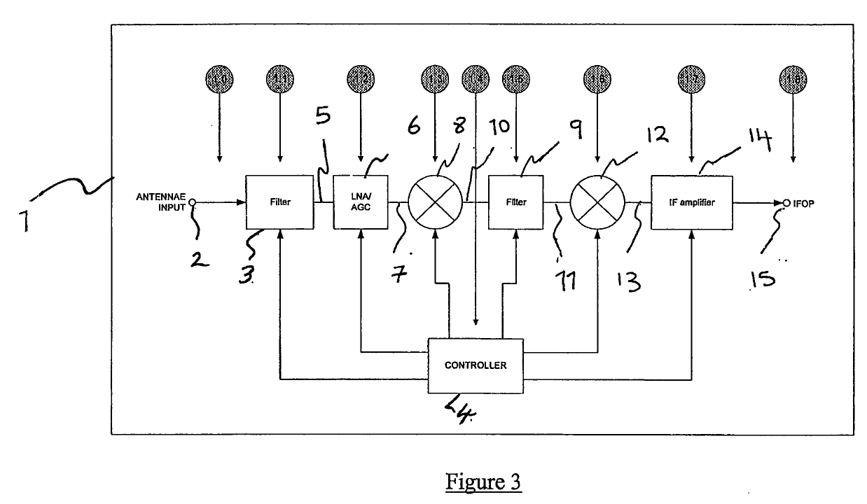

With reference to FIG. 3, a double conversion tuner 1 is illustrated. This tuner is designed to select a chosen channel, typically a digital channel, from a multichannel input signal which comprises both digital and analogue channels. The signal occupies some specified frequency spectrum and may be pre-filtered to isolate this spectrum. The tuner described here is designed for use in a digital television receiver.

The signal received from an antennae is connected directly to a tuner input terminal 2. The input terminal 2 is connected to a first filter 3. A key feature of this filter is that it is tuneable so as to have a minimum insertion loss at the desired channel and will present attenuation to far out interferers. Minimisation of bandwidth is not a prerequisite; indeed it may be desirable to operate with a wide bandwidth to achieve a minimum insertion loss. The desired passband frequency will be selected by a system controller 4, which will select a passband corresponding to the desired channel. The first filter provides a broadband system selectivity.

The filter 3 may be of a continuously variable type, or may comprise a number of discrete filters having pass bands arranged to be contiguous over the frequency of operation, with means for switching the filter input and output to the input and output of a chosen discrete filter. The filter bandwidth(s) may be variable or fixed.

The output 5 of the filter 3 is connected to a variable gain stage 6. This stage will provide the system RF automatic gain control (AGC) facility and will be arranged to have a wide spurious free dynamic range, i.e. it will have a low input Noise Figure (i.e this stage 6 will degrade the signal-to-noise ratio only to a very small extent) and high input intermodulation intercept. Gain control in this stage will be provided by the system controller 4. The required gain setting may be determined from a combination of the measured power in the desired channel and the immediate adjacents, and the total composite power output from the first variable gain stage (or any combination of these measured values). Classic mechanisms for controlling the AGC are well known and documented and will not be described in detail here.

The output 7 of the variable gain stage 6 is connected to a first frequency conversion stage 8. This stage block upconverts the input spectrum to a high IF frequency and centres the desired channel on the passband of a second filter 9. The conversion stage 8 comprises a mixer, a local oscillator (LO) for providing the commutating signals to the mixer, and a frequency synthesiser for controlling the frequency of the LO. The high IF frequency will normally lie above the highest frequency of the received spectrum. The LO frequency for the desired channel will be selected by the system controller 4.

The second filter 9 which is coupled to an output 10 of the first frequency conversion stage may be of fixed bandwidth and centre frequency or may be variable in either or both parameters (in the lalter case the filter will be controlled by the system controller 4). The second filter 9 provides further selectivity though will normally pass near adjacent interferers. The principal function of this filter is to provide image cancellation.

The output 11 of the second filter 9 is passed to a second frequency conversion stage 12. This stage downconverts the desired channel at the high IF frequency to an output IF frequency, normally in the range 30 to 60 MHz. The conversion stage 12 will contain a mixer and a LO for providing the commutating signals to the mixer, and a frequency synthesiser for controlling the frequency of the LO. The LO frequency will normally lie above the highest frequency of the received spectrum. The second conversion stage may provide further system image cancellation. The LO frequency for the desired channel will be selected by the system controller 4. The output 13 of the second converter 12 is coupled to an IF amplifier 14 which provides further gain and provides the desired channel signal to a tuner output 15.

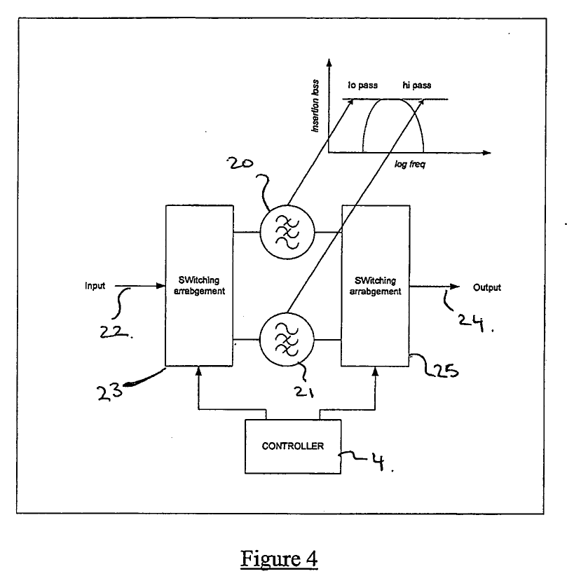

The first filter 3 may be implemented to provide two or more sub-bands whose passbands are contiguous over the required frequency range. FIG. 4 illustrates one suitable filter configuration which comprises two filters 20,21 providing two contiguous passbands. Each filter 20,21 may be implemented for example using passive LC configurations and is arranged to provide attenuation to interferers located at a substantial frequency offset to the desired channel. The filters 20,21 share a common input 22 with switching isolation 23 between the two paths, and share a common output 24 with switching isolation 25 between the two paths. In an alternative configuration, the outputs from the filters may be coupled into respective input stages of the following variable gain stage 6, and the appropriate filter band selected by selecting the appropriate input to the variable gain stage 6 (a combination of the two techniques may be applied).

These filter and switching arrangements may be implemented in whole or in part on an integrated circuit as the filters do not require a high Q factor; integrated inductors are well known to have poor Q factor. The controller 4 may provide a number of switching ports for controlling the external or internal path selection. In operation, the appropriate filter band would be selected by the controller 4 to pass the desired channel. The required band may be determined by design or through a filter calibration sequence, which may be carried out during a production alignment procedure, or through a calibration algorithm run on power up. The calibration routine might use a slave oscillator, which is activated during the calibration routine only. A possible calibration routine is described in EP1278304.

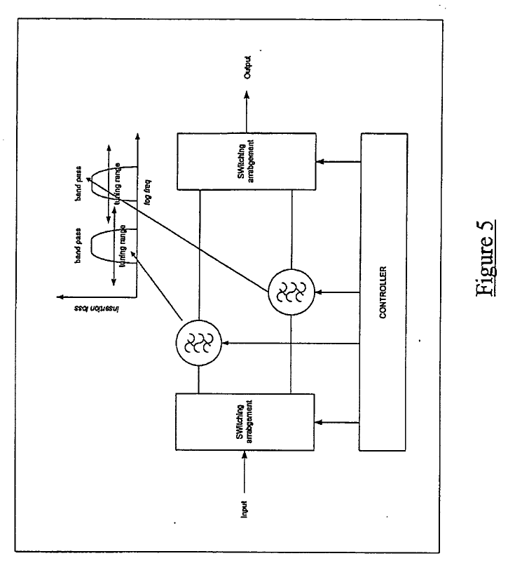

In an alternative arrangement to that illustrated in FIG. 4, the first filter 3 may consist of one or more variable filters whose passbands are arranged to be contiguous over the required operational frequency range. Such an arrangement is illustrated in FIG. 5. In this implementation the number of required filter paths may be reduced as compared to that required in the arrangement of FIG. 4. These filters may be implemented as for example an LC filter where at least one element is electronically variable; normally this element would be a varactor diode, i.e. a component whose capacitance is inversely proportional to the applied reverse bias voltage. Alternately a reactive element may consist of for example a binary weighted array with elements switched in or out to provide ‘digital’ tuning.

The second filter 9 may be of fixed bandwidth implementation, such as a SAW filter or dielectric filter or an LC configuration, arranged to provide a first suppression of the image frequency. In the case of implementations using an LC configuration, as the components used to manufacture the filter will have a normal production tolerance, the centre frequency of the filter will have a manufacturing spread. To overcome this potential problem, the filter characteristic may be measured and adjusted during production alignment to give the desired characteristic. Alternately, after measurement the control software could be adjusted to provide the desired characteristic. In another alternative, a calibration routine may be applied which uses a slave oscillator, activated during for example power up, whereby the characteristic of the second filter is electronically measured and the software adjusted to correctly position the desired and image channel (after upconversion) on the determined filter characteristic. As with the first filter, the second filter arrangement may be implemented in whole or in part on an integrated circuit. The inductive element of the filter may utilise in whole or in part the bond wire inductance. In this case, because the frequency of the filter is higher, it is more suitable to integration since the element values would be small.

In an alternative arrangement, the second filter 9 may have a variable centre frequency and or bandwidth characteristic. This filter may be implemented as for example an LC filter where at least one element is electronically variable; normally this would be a varactor diode, i.e. a component whose capacitance is inversely proportional to the applied reverse bias voltage. Alternately a reactive element may consist of for example a binary weighted array with elements switched in or out to give ‘digital’ tuning. The tuning range of the filter would normally be sufficient to cover any manufacturing tolerance such that the characteristic can be electronically adjusted to provide a predetermined filter characteristic. The tuning voltage for the filters may be provided by one or more DAC outputs from the controller 4.

To align the filter 9 one might for example measure the passband characteristic in production, and then adjust the characteristic by applying an appropriate control voltage (stored within the software) to the variable element to give the desired characteristic. Alternately, a calibration routine may be applied which uses a slave oscillator activated during the calibration routine, whereby the characteristic of the second filter is electronically determined and an appropriate control voltage for the variable element derived

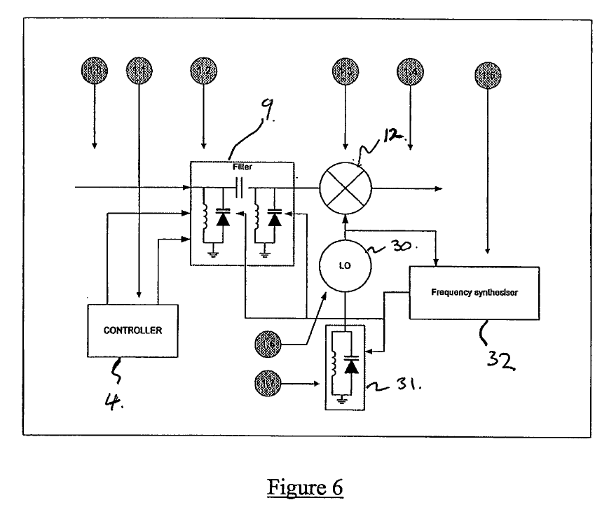

An alternative implementation of the second filter 9 is illustrated in FIG. 6. In this arrangement the filter 9 has a similar tuning element and control mechanism to the second frequency conversion stage 12. The output from the first conversion stage 8 (not shown) is connected to the second filter 9. In this example the filter 9 is shown as having a double tuned loosely coupled bandpass configuration. The filter 9 is constructed from two parallel tuned networks consisting of an inductor and varactor. The output of the filter 9 is connected to the second frequency conversion stage 12, which in turn outputs the desired channel plus any undesired signals which also pass through the second filter 9.

The commutating signal for the mixer of the frequency converter 12 is generated by a local oscillator (LO) 30 whose oscillation frequency is determined by a resonant tank 31 (shown as a parallel resonant circuit of similar construction to the filter resonant elements). The LO frequency is controlled by a PLL frequency synthesiser 32 which generates a control voltage for adjusting and hence varying the capacitance of the reverse bias on the varactor diode of the LO resonant tank 31. This control voltage is also connected in parallel to the tuning elements within the filter 9. The tuning elements within the filter 9 and the LO circuit 30 are substantially similar in construction, such that any adjustment in the local oscillator frequency will cause a similar shift in the filter passband frequency.

By use of such tank arrangements, and as the tuning range is limited, it is possible to generate a relatively constant offset between the resonant frequencies of the two networks 9,31 which can be arranged to correspond to for example the output IF frequency, so centring the filter passband on the desired channel. The absolute accuracy will be determined by the manufacturing tolerance of the resonator components and other manufacturing issues. In practice, due to manufacturing tolerances, the absolute frequencies of the two networks may be offset from a desired value by a similar amount in each case, due to the similarity of the networks. When the frequency of the LO 30 is locked to a desired value by the PLL frequency synthesiser, the passband of the filter 9 is adjusted in synchronisation, so centring both resonators on their desired values.

In a real application the tuning adjustments may consist of an array of varactors switched in series to extend the tuning range. Similarly there may be a switched value of capacitance added to both networks to extend their tuning ranges.

To further enhance the performance of the illustrated arrangement a delta offset voltage may be applied by the controller 4 to elements within the filter arrangement 9 to fine-tune the frequency of operation. This could be achieved by a similar calibration method as described above. Such an offset voltage could also be added to the control voltage generated by the frequency synthesiser so giving individual control voltage lines for the individual resonator elements.

The arrangement described is highly suited to an integrated circuit implementation where the inductive elements are formed from matched bond-wire or chip inductances, and the matched varactors are part of an associated integrated circuit, so minimising component tolerance. In an alternative embodiment the varactor element could be replaced by a binary weighted capacitive array.

By the application of this invention it is possible to deliver a tuner which offers improved performance to both far out and near interferers whilst being highly suited to integration as a ‘single-chip’ tuner.

1. A tuner comprising:
a signal input for receiving an input signal comprising multichannel data;
a filter having an input coupled to said signal input, the filter being tunable to pass a selected frequency channel;
a first frequency changer having an input coupled to an output of said filter and arranged to upconvert the filtered input signal so that said selected frequency channel is shifted to a predefined high intermediate frequency;
a second filter having an input coupled to an output of said first mixer and arranged to pass said predefined high intermediate frequency; and
a second frequency shifter having an input coupled to an output of said second filter and arranged to downconvert the filtered high intermediate frequency to a predefined output frequency.

2. A tuner according to claim 1 and comprising a controller arranged to tune the first mentioned filter and the first frequency changer.

3. A tuner according to claim 1, the first mentioned filter comprising at least two sub-filters, the passbands of the sub-filters being substantially contiguous, and the sub-filters being selectably coupled between the input and output of the filter to provide the tuning.

4. A tuner according to claim 3, wherein the passbands and centre frequencies of the sub-filters are individually tuneable.

5. A tuner according to claim 1, wherein the second filter has a fixed centre frequency and passband.

6. A tuner according to claim 1, wherein one or both of the centre frequency and the passband of the second filter are variable by tuning the second filter.

7. A tuner comprising:
a signal input for receiving an input signal comprising multichannel data;
a filter having an input coupled to said signal input, the filter being arranged to pass a selected frequency channel;
a first frequency changer having an input coupled to an output of said filter and arranged to upconvert the filtered input signal so that said selected frequency channel is shifted to a predefined high intermediate frequency;
a second filter having an input coupled to an output of said first mixer, the second filter being tuneable so as to pass said predefined high intermediate frequency; and
a second frequency shifter having an input coupled to an output of said second filter and arranged to downconvert the filtered high intermediate frequency to a predefined output frequency.

8. A tuner according to claim 7, wherein the tuner comprises a controller arranged to tune said second filter and the first frequency changer.

9. A tuner according to claim 8 and comprising means for synchronizing the tuning range of said second filter with the frequency shift provided by said second frequency shifter.

10. A tuner according to claim 1, wherein substantially all of the components of the tuner are integrated into an integrated circuit.

11. A tuner according to claim 10, wherein inductances of the second filter and/or the second frequency shifter are provided at least in part by bond wire inductances.

12. A tuner according to claim 1, wherein the second filter and the second frequency shifter comprise matched components chosen to compensate for manufacturing tolerances.

13. A tuner according to claim 12, wherein said matched components include varactor diodes.
